(19) United States
(12) Patent Application Publication
(10) Pub. No.: US 2004/0257625 A1
(43) Pub. Date: Dec. 23, 2004

(54) Apparatus for, method of, and system for image processing

(76) Inventor: Kazunari Tonami, Kanagawa (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/821,612

(22) Filed: Apr. 9, 2004

(30) Foreign Application Priority Data
Apr. 15, 2003 (JP) 2003-110856

(51) Int. Cl. G06K 15/00; G06K 9/00; B41M 3/10; G06T 5/00

(52) U.S. Cl. 358/3.28; 382/100; 348/231.6; 382/261; 358/519

(57) ABSTRACT

An image processing apparatus has a first information addition unit configured to add to image data information related to image processing of the image data according to a first addition method as first information, and a second information addition unit configured to add the information to the image data according to a second addition method different from the first information addition method as second information. At least one of the first and the second information added is not lost even when an image processing is performed with respect to the image data.

The present application claims priority to the corresponding Japanese Application No. 2003-110856, filed on Apr. 15, 2003, the entire contents of which are hereby incorporated by reference.

### BACKGROUND OF THE INVENTION

1. Field of the Invention

The present invention relates to image processing using information added to image data.

2. Description of the Related Art

When image data created by an image input device such as a scanner or a digital camera is output by an image output device such as a color printer, image processing such as color conversion processing, density correction processing, and modulation transfer function (MTF) correction are heretofore performed.

When such image processing is performed, the most suitable processing should be performed corresponding to the characteristics of respective image data, in order to output a high quality image with respect to various kinds of image data.

Therefore, performing high quality image processing by adding information relating to the image and information such as a processing parameter to the image data, and performing processing based on the added information at the time of performing the image processing has been considered.

As a conventional example of this type, there is a technique in which a correction parameter of the image data is added to an extension tag of a file, and image processing such as gamma correction is performed based on the tag information (see Patent Literature 1: Japanese Patent Application Laid-Open No. 2000-137806).

There is another technique in which histogram information associated with image data is embedded as an electronic watermark, and the image output device performs color processing based on the extracted information (see Patent Literature 2: Japanese Patent Application Laid-Open No. 2001-127985).

Further, there is a technique in which image quality correction information is embedded as an electronic watermark by a digital camera, and a reproducer performs image quality correction based on the image quality correction information extracted from the image data (see Patent Literature 3: Japanese Patent Application Laid-Open No. 2000-196937).

In such a conventional image processing apparatus, however, when the information is described in the tag, as in the Patent Literature 1, there is a problem in that information may be lost by file format conversion.

Further, as in the Patent Literature 2 or 3, when the information is embedded in the image data as the electronic watermark, there is a possibility that the information is lost by performing image processing such as resolution conversion, and since extraction processing of the electronic watermark takes time, there is a problem in that performing the electronic watermark extraction with respect to all image data deteriorates the throughput.

### SUMMARY OF THE INVENTION

An apparatus for, method of, and system for image processing are described. In one embodiment, the image processing apparatus comprises: a first information addition unit to add, to image data, information related to image processing of the image data according to a first addition method as first information, and a second information addition unit to add the information to the image data according to a second addition method different from the first information addition method as second information, wherein at least one of the first and the second information added is not lost even when an image processing is performed with respect to the image data.

### BRIEF DESCRIPTION OF THE DRAWINGS

FIG. 1 is a block diagram for illustrating a schematic configuration of an image input device as an example of an image processing apparatus according to one embodiment of the present invention;

FIG. 2 is a block diagram for illustrating a schematic configuration of an image output device as an example of the image processing apparatus according to one embodiment of the present invention;

FIG. 3 depicts a configuration example of a created image data file;

FIG. 4 is a flowchart for illustrating the procedure for adding information relating to image processing to image data in an information addition unit in FIG. 1;

FIG. 5 is a flowchart for illustrating the procedure for performing the image processing based on the information added to the image data by an information extractor and an image processing apparatus in FIG. 2 in one embodiment;

FIG. 6 is a flowchart for illustrating the procedure for adding information relating to the image processing to the image data by the information addition unit in FIG. 1 in one embodiment; and

FIG. 7 is a flowchart for illustrating the procedure for performing the image processing based on the information added to the image data by the information extractor and the image processing apparatus in FIG. 2 in one embodiment.

### DETAILED DESCRIPTION

One or more embodiments of the present invention solve at least the problems in the conventional technology.

An image processing apparatus according to an embodiment of the present invention has a first information addition unit to add to image data information related to image processing of the image data according to a first addition method as first information; and a second information addition unit to add the information to the image data according to a second addition method different from the first information addition method as second information, wherein at least one of the first and the second information added is not lost even when an image processing is performed with respect to the image data.

An image processing apparatus according to another embodiment of the present invention has a first information extractor to extract, from image data, information related to image processing of the image data according to a first extraction method; a second information extractor to extract the information from the image data according to a second extraction method different from the first extraction method, when the information cannot be extracted by the first information extractor; and an image processing unit to perform the image processing based on the information extracted by one of the first information extractor and the second information extractor.

An image processing method according to still another embodiment of the present invention has adding, to image data, information related to image processing of the image data according to a first addition method as first information; and adding the information to the image data according to a second addition method different from the first information addition method as second information, wherein at least one of the first and the second information added is not lost even when an image processing is performed with respect to the image data.

An image processing method according to still another embodiment of the present invention has extracting, from image data, information related to image processing of the image data according to a first extraction method; extracting the information from the image data according to a second extraction method different from the first extraction method, when the information cannot be extracted by the first information extractor; and performing the image processing based on the information extracted.

An image processing system according to still another embodiment of the present invention includes the image input apparatus and the image output apparatus according to the above embodiments of the present invention.

The other embodiments, features, and advantages of the present invention are specifically set forth in or will become apparent from the following detailed description of the invention when read in conjunction with the accompanying drawings.

Exemplary embodiments of an image processing apparatus, an image processing method, and an image processing system according to one embodiment of the present invention will be explained with reference to the accompanying drawings.

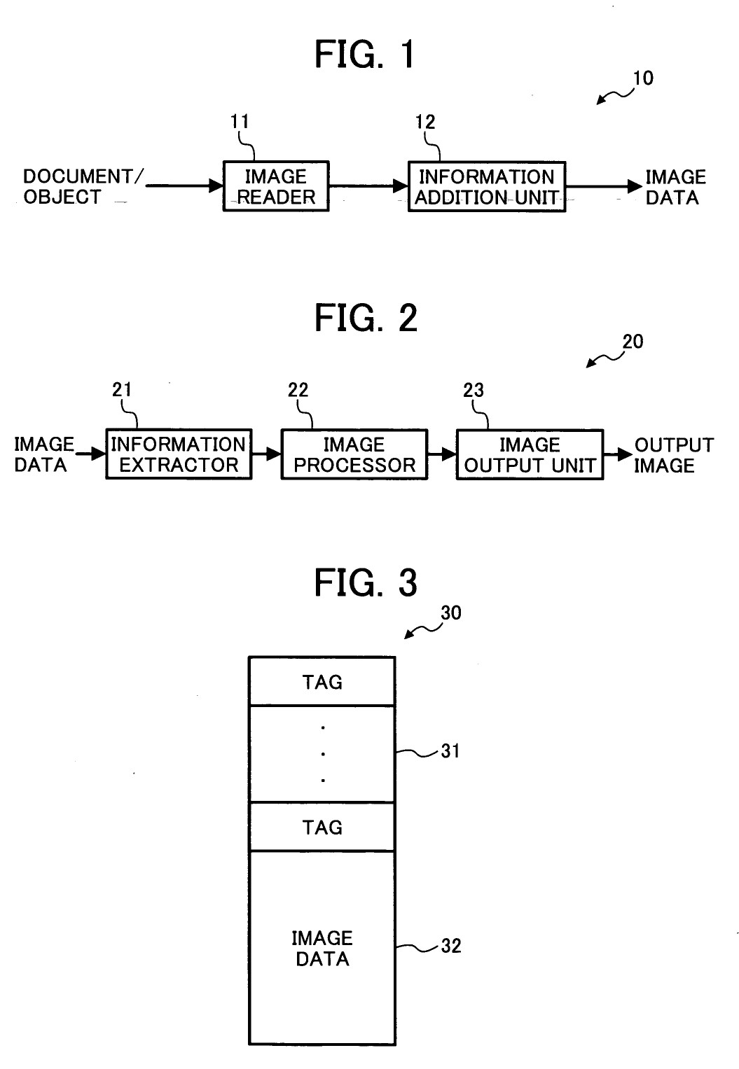

FIG. 1 is a block diagram for illustrating a schematic configuration of an image input device as an example of an image processing apparatus according to one embodiment of the present invention, and FIG. 2 is a block diagram for illustrating a schematic configuration of an image output device as an example of the image processing apparatus according to one embodiment of the present invention.

An image input device 10 in FIG. 1, such as a scanner or a digital camera, reads image from a document or a object. The image input device 10 reads the image of a document or a object by an image reader 11, and converts the image to image data having, for example, 256 tones respectively for red (R), green (G), and blue (B), then the image data is created by adding information relating to the image data in an information addition unit 12.

An image output device 20 in FIG. 2, such as a printer, records the input image on a medium such as recording paper. The image output device 20 extracts information relating to the image processing of the image data from the input image data by an information extractor 21. An image processor 22 performs image processing based on information relating to the image processing extracted from the image data, and records the image on the recording paper (medium) in an image output unit 23, to obtain an output image. The image output device 20 may be a display unit such as a display other than the printer.

Characteristic components in the present invention are the information addition unit 12 in FIG. 1, the information extractor 21, and the image processor 22 in FIG. 2, and these will be specifically explained below.

In one embodiment, an instance when the characteristic of an MTF of the scanner is added as the information relating to the image processing of the image data, and when MTF correction filtering processing is performed by the image processor 22 in FIG. 2 will be explained. The MTF correction filtering processing is, for example, filtering processing for performing MTF correction to emphasize the edge information in a character portion or a pattern portion in an image, such as Laplacian corresponding to 3×3 pixel matrix.

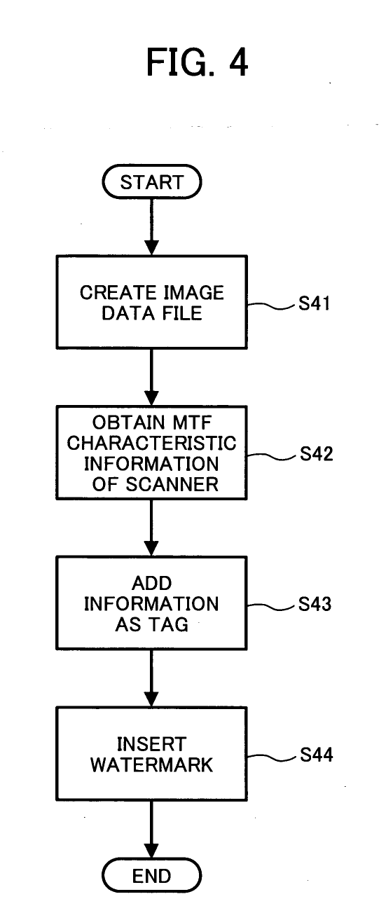

FIG. 3 depicts a configuration example of a created image data file, and FIG. 4 is a flowchart for illustrating the procedure for adding information relating to the image processing to the image data in an information addition unit in FIG. 1.

As shown in FIG. 4, the information addition unit 12 in FIG. 1 creates the image data having 256 tones respectively for RGB read by the image reader 11 on the previous stage as a predetermined file format (step S41). The data file created at step S41 includes a tag region 31 and an image data region 32 as shown in FIG. 3.

The information addition unit 12 obtains information of the MTF characteristic of the scanner, being the image input device 10 (step S42), and adds the information as a tag to the tag region 31 in an image data file 30 shown in FIG. 3 (step S43).

Lastly, by embedding the MTF characteristic of the scanner, being the image input device 10 in the image data, as an electronic watermark (step S44), the information relating to the image processing is added by the tag and by the electronic watermark, and is output from the scanner as the image data file 30. The electronic watermark is a technique for embedding information so that the information cannot be seen by human eyes, and can be executed by using a known technique.

The operation for outputting data from a printer, being the image output device 20 in FIG. 2, by using the image data file created in this manner will be explained below. Generally, since high frequency components decrease in the MTF characteristic of the scanner, the image information for the high frequency components is insufficient in the image read by the scanner, and the image becomes slightly unclear. Therefore, by emphasizing the high frequency components by using the MTF correction filter, a sharp image can be obtained.

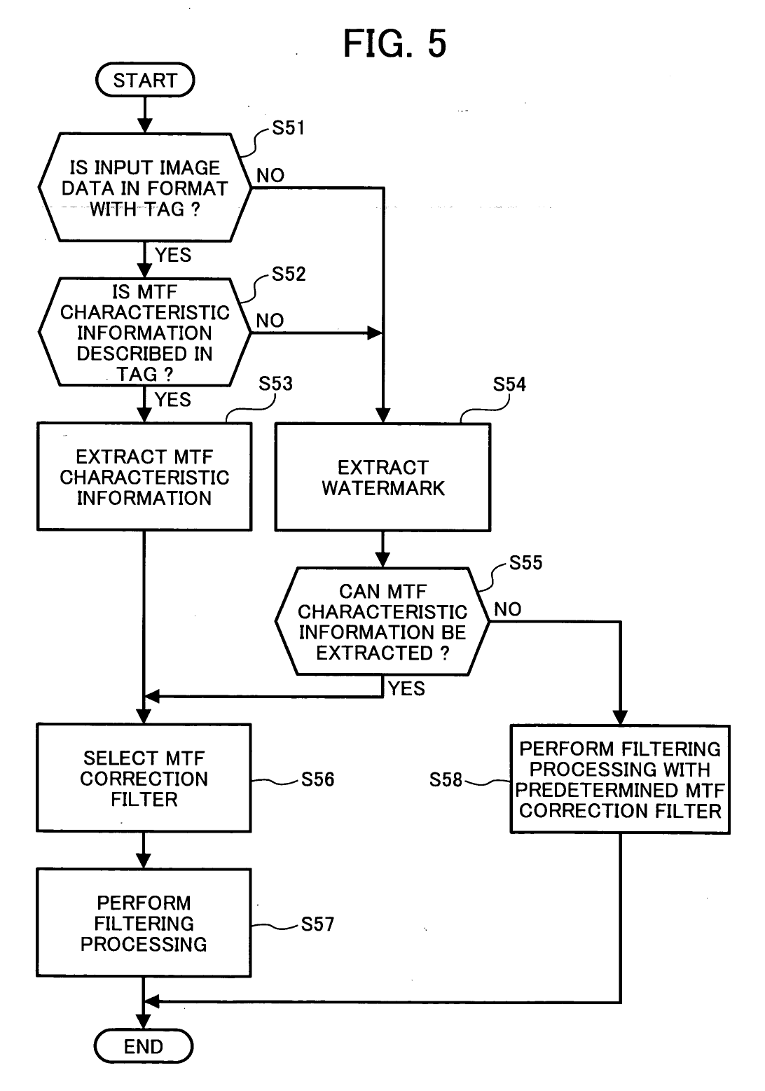

FIG. 5 is a flowchart for illustrating the procedure for performing the image processing based on the information added to the image data by the information extractor and the image processing apparatus in FIG. 2 in one embodiment.

As shown in FIG. 5, the information extractor 21 of the printer, being the image output device 20, determines whether the input image data file is in a format with a tag (step S51), and when it is in a format with a tag, the information extractor 21 checks if information relating to the MTF characteristic of the scanner is described in the tag at step S52, and when the information is described in the tag, the information extractor 21 extracts the information relating to the MTF characteristic (step S53).

At step S51, if the input image data file is not in the format with a tag, or at step S52, if the input image data file is in the format with a tag, but the information relating to the MTF characteristic of the scanner is not described in the tag, the information extractor 21 extracts an electronic watermark from the image data (step S54), and determines whether the information relating to the MTF characteristic of the scanner is embedded as the electronic watermark (step S55).

If the information relating to the MTF characteristic of the scanner can be extracted from the tag (step S53) or the electronic watermark (step S55), the best MTF correction filter is selected based on the MTF characteristic (step S56), and filtering processing is performed using the filter (step S57).

On the other hand, if the information relating to the MTF characteristic of the scanner cannot be extracted from the tag or the electronic watermark (when NO at step S55), the filtering processing is performed, using a predetermined MTF correction filter (step S58).

As described above, according to one embodiment, the image data created by the image input device 10 is not always output directly from the image output device 20, and for example, image processing such as resolution conversion, rotation, or cutting may be performed, or the image data may be output after the file format is converted. According to the configuration explained in one embodiment, even if various kinds of image processing are performed, if the file format itself is not changed, the information added to the tag is not lost. As a result, the information relating to the MTF characteristic of the scanner can be extracted from the tag.

According to one embodiment, when the file format conversion is performed, the information added to the tag is lost. However, since the information embedded in the image data as the electronic watermark remains, the information relating to the MTF characteristic of the scanner can be extracted based on the electronic watermark. In other words, if the information remains in either one of the tag or the electronic watermark, the information relating to the MTF characteristic of the scanner (information relating to the image processing) can be extracted. Therefore, there is an advantage in that the possibility of losing the information can be reduced by half or less, as compared with when the information is added either in the tag or in the electronic watermark.

Since extraction of the electronic watermark takes time, determination of whether the information relating to the MTF characteristic of the scanner is embedded as the electronic watermark with respect to all images leads to a drop in the throughput. According to one embodiment of the present invention, however, since extraction of the electronic watermark is performed only when the information cannot be extracted from the tag, high-speed image output becomes possible, as compared with when extraction of the electronic watermark is performed with respect to all images.

In one embodiment, an example in which a gamma correction parameter of the image data is added as the information relating to the image processing of the image data, and the gamma correction processing is performed in the image processing apparatus will be explained.

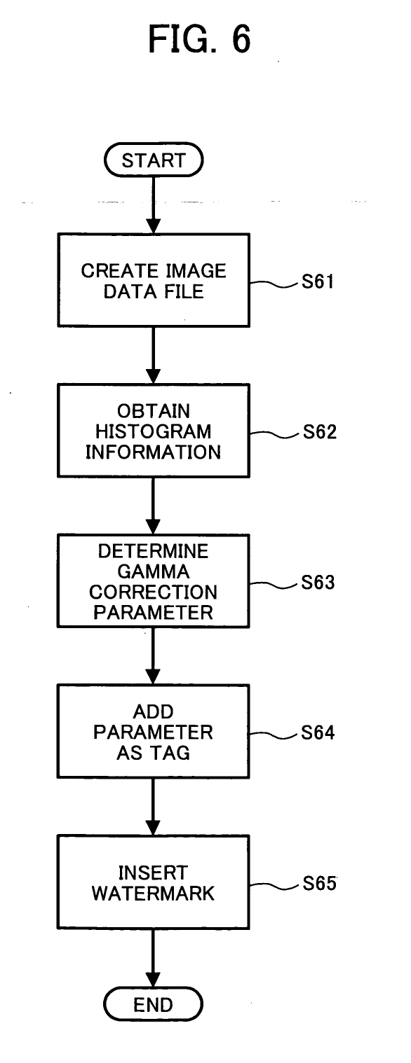

FIG. 6 is a flowchart for illustrating the procedure for adding information relating to the image processing to the image data by the information addition unit in FIG. 1 in one embodiment.

The information addition unit 12 in FIG. 1 creates image data of respective 256 tones of RGB read by the image reader 11 on the previous stage in a predetermined file format (step S61). The processing is the same as at step S41 in FIG. 4 in one embodiment, and the image data file structure includes the tag region 31 and the image data region 32 as shown in FIG. 3.

The information addition unit 12 obtains histogram information of the image data after having created the image data file (step S62).

The information addition unit 12 then determines a parameter for the gamma correction processing based on the obtained histogram information (step S63).

The information addition unit 12 adds the determined parameter as a tag to the image data (step S64).

The parameter determined at step S63 is also embedded in the image data as an electronic watermark (step S65).

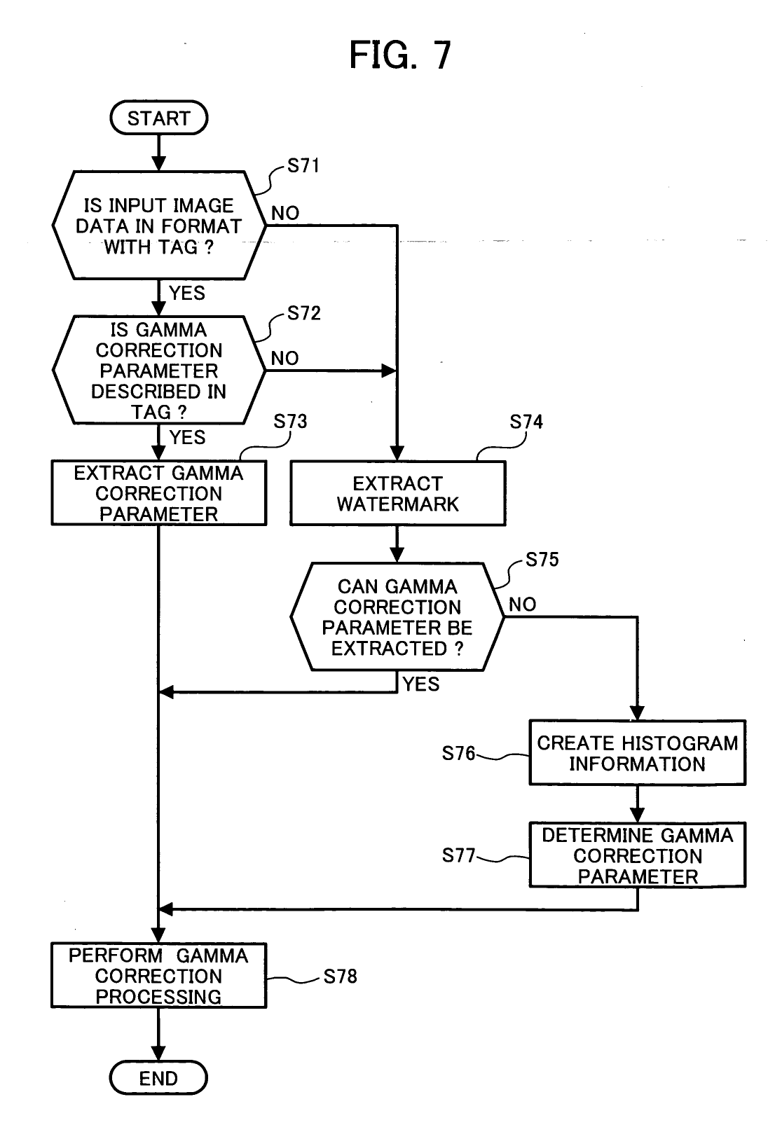

FIG. 7 is a flowchart for illustrating the procedure for performing the image processing based on the information added to the image data, by the information extractor and the image processing apparatus in FIG. 2 in one embodiment.

As shown in FIG. 7, the information extractor 21 in the printer, being the image output device 20, determines whether the input image data file is in a format with a tag (step S71). When it is in the format with a tag, the information extractor 21 checks if the gamma correction parameter is described in the tag at step S72, and if the information is described in the tag, extracts the gamma correction parameter (step S73).

At step S71, when the image data file is not in the format with a tag, or when the image data file is in the format with a tag, but the parameter for the gamma correction processing is not described therein, the information extractor 21 extracts the electronic watermark from the image data (step S74), and determines whether the gamma correction parameter is embedded therein as the electronic watermark (step S75).

At step S75, if the gamma correction parameter cannot be extracted from the electronic watermark, histogram information is created from the image data (step S76), and the parameter for the gamma correction processing is determined based on the histogram information (step S77).

The gamma correction processing is performed by using the parameter for the gamma correction processing obtained in this manner (step S78).

According to one embodiment, as in the previous embodiment, only when the information relating to the image processing cannot be extracted from the tag, extraction of the electronic watermark is performed. As a result, a high-quality image can be output at a high speed.

Further, according to one embodiment, when the information cannot be extracted from either of the tag or the electronic watermark, the gamma correction parameter is determined by analyzing the image data. Therefore, even when the information relating to the image processing cannot be extracted from either of the tag or the electronic watermark, a high-quality image can be output. In this case, since analysis processing of the image data takes time, if the image data is always analyzed when the information cannot be extracted from any of the tag and the electronic watermark, the processing time increases. Therefore, it is more desired to provide a function of selecting whether to perform the gamma correction processing by analyzing the image data or to output the data without performing the gamma correction processing, by a user according to the situation.

In the above described embodiments, the information relating to the image processing is added to the image data by using both the tag and the electronic watermark, but the present invention is not limited thereto, and the information may be added by using a pattern like a barcode, or a dot pattern of a specific color, instead of the electronic watermark. Since these patterns are directly added to the image data, as in the electronic watermark, even if file format conversion is performed, the information is not lost. Therefore, by adding the information relating to the image processing to the image data by using the tag and any one of the information adding units, preferable effects can be obtained as described above.

In the above described embodiments, as the information relating to the image processing of the image data, the MTF characteristic of the scanner or histogram is used, but the present invention is not limited thereto. For example, information used at the time of performing the image processing, such as the illumination condition at the time of reading the image, or any information of a parameter at the time of performing the image processing can be used as other information.

According to one embodiment of the invention, the information relating to the image processing of the image data is added to the image data according to a first method by the first information addition unit, and the information relating to the image processing is added to the image data according to a second method, different from that of the first information addition unit, by the second information addition unit, so that even if optional image processing is performed on the image data, at least one of the information added by the first and the second information addition units is held. As a result, the information relating to the image processing embedded in the image data is hardly lost, thereby enabling high quality image processing.

According to one embodiment of the invention, the first information addition unit adds the information relating to the image processing of the image data to the image data as a tag, and the second information addition unit adds the information relating to the image processing of the image data to the image data as an electronic watermark. Therefore, even if the information in the tag is lost by file format conversion, the information in the electronic watermark remains. Further, even if the information embedded as the electronic watermark is lost due to image processing such as resolution conversion, the information in the tag remains. As a result, the information relating to the image processing embedded in the image data beforehand is hardly lost, thereby enabling high quality image processing.

According to another embodiment of the invention, the first information addition unit adds the information relating to the image processing of the image data to the image data as a tag, and the second information addition unit embeds the information relating to the image processing of the image data in the image data as a specific pattern. Therefore, even if the information in the tag is lost due to file format conversion, the information in the specific pattern remains, and even if the information embedded as a specific pattern such as a barcode or a dot pattern of a specific color is lost due to image processing such as resolution conversion, the information in the tag remains. As a result, the information relating to the image processing embedded in the image data beforehand is hardly lost, thereby enabling high quality image processing.

According to one embodiment of the invention, the information relating to the image processing is extracted from the input image data by the first information extractor, and when the information relating to the image processing cannot be extracted by the first information extractor, the information relating to the image processing is extracted according to a method different from that of the first information extractor by the second information extractor, so that the image processing is performed based on the information relating to the image processing extracted by either one of the first information extractor and the second information extractor. As a result, even when image processing is performed, the information embedded in the image data beforehand is hardly lost, thereby enabling high quality image processing.

According to the another embodiment of the invention, the first information extractor extracts the information relating to the image processing of the image data from the tag added to the image data, and the second information extractor extracts the information relating to the image processing of the image data embedded in the image data as an electronic watermark. Therefore, even if the information in the tag is lost due to file format conversion, the information in the electronic watermark remains, and even if the information embedded as the electronic watermark is lost due to image processing such as resolution conversion, the information in the tag remains. As a result, the information relating to the image processing embedded in the image data beforehand is hardly lost, and when the information is described in the tag, information extraction from the electronic watermark is not performed, thereby enabling high quality image processing without requiring excess processing time.

According to another embodiment of the invention, the first information extractor extracts the information relating to the image processing of the image data from the tag added to the image data, and the second information extractor extracts the information relating to the image processing of the image data from information added as a specific pattern. Therefore, even if the information in the tag is lost due to file format conversion, the information in the specific pattern remains, and even if the information embedded as a specific pattern such as a barcode or a dot pattern of a specific color is lost due to image processing such as resolution conversion, the information in the tag remains. As a result, the information relating to the image processing embedded in the image data beforehand is hardly lost, thereby enabling high quality image processing.

According to one embodiment of the invention, when the information relating to the image processing of the image data cannot be extracted by any of the first information extractor and the second information extractor, predetermined image processing is performed. As a result, for example, even when the information relating to the image processing cannot be extracted from either of the tag or the electronic watermark, high quality image output can be performed.

According to yet another embodiment of the invention, when the information relating to the image processing of the image data cannot be extracted by any of the first information extractor and the second information extractor, the characteristic of the image is extracted from the image data and image processing is performed based on the extracted characteristic of the image. As a result, for example, even when the information relating to the image processing cannot be extracted from either of the tag or the electronic watermark, image processing can be performed based on the characteristic of the image, thereby enabling high quality image output.

According to another embodiment of the invention, the information relating to the image processing of the image data is added to the image data by a first method at the first information addition step, and the information relating to the image processing is added to the image data by a second method different from that at the first information addition step, at the second information addition step, so that even if optional image processing is performed on the image data, at least one of the information added at the first and the second information addition steps is held. As a result, the information relating to the image processing embedded in the image data is hardly lost, thereby enabling high quality image processing.

According to the one embodiment of the invention, the information relating to the image processing is extracted from the input image data at the first information extraction step, and when the information relating to the image processing cannot be extracted at the first information extraction step, the information relating to the image processing is extracted at the second information extraction step according to a method different from that at the first information extraction step, so that the image processing is performed based on the information relating to the image processing extracted at either the first information extraction step or the second information extraction step. As a result, even when image processing is performed, the information embedded in the image data beforehand is hardly lost, thereby enabling high quality image processing.

According to one embodiment of the invention, the image processing system includes: the image input device that adds the information relating to the image processing of the image data to the image data according to a first method by the first information addition unit, and adds the information relating to the image processing to the image data according to a second method different from the first method by the second information addition unit, so that even when optional image processing is performed with respect to the image data, at least one of the information added by the first and the second information addition units is held; and the image output device that extracts the information relating to the image processing from the image data input by the image input device by the first information extractor, and extracts the information relating to the image processing according to a method different from that of the first information extractor by the second information extractor, when the information relating to the image processing cannot be extracted by the first information extractor, so that the image processing is performed based on the information relating to the image processing extracted by either one of the first information extractor and the second information extractor, to output the image. As a result, even when image processing is performed, the information embedded in the image data beforehand is hardly lost, thereby enabling high quality image processing without requiring excess processing time.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An image processing apparatus comprising:
a first information addition unit to add, to image data, information related to image processing of the image data according to a first addition method as first information; and
a second information addition unit to add the information to the image data according to a second addition method different from the first information addition method as second information, wherein at least one of the first and the second information added is not lost even when an image processing is performed with respect to the image data.

2. The image processing apparatus according to claim 1, wherein
the first information addition unit adds the information to the image data as a tag, and
the second information addition unit embeds the information in the image data as an electronic watermark.

3. The image processing apparatus according to claim 1, wherein
the first information addition unit adds the information to the image data as a tag, and
the second information addition unit embeds the information in the image data as a specific pattern.

4. An image processing apparatus comprising:
a first information extractor to extract, from image data, information related to image processing of the image data according to a first extraction method;
a second information extractor to extract the information from the image data according to a second extraction method different from the first extraction method, when the information cannot be extracted by the first information extractor; and
an image processing unit to perform the image processing based on the information extracted by one of the first information extractor and the second information extractor.

5. The image processing apparatus according to claim 4, wherein
the first information extractor is operable to extract the information from a tag that has been added to the image data, and
the second information extractor is operable to extract the information from an electronic watermark that has been embedded in the image data.

6. The image processing apparatus according to claim 4, wherein
the first information extractor is operable to extract the information from a tag that has been added to the image data, and
the second information extractor is operable to extract the information from a specific pattern that has been added to the image data.

7. The image processing apparatus according to claim 4, wherein the image processing unit is operable to perform a predetermined image processing with respect to the image data when the information cannot be extracted by the first information extractor and the second information extractor.

8. The image processing apparatus according to claim 4, further comprising a third information extractor to extract image characteristics from the image data when the information cannot be extracted by the first information extractor and the second information extractor, wherein
the image processing unit is operable to perform the image processing based on the image characteristics extracted.

9. An image processing method comprising:
adding, to image data, information related to image processing of the image data according to a first addition method as first information; and
adding the information to the image data according to a second addition method different from the first information addition method as second information,
wherein at least one of the first and the second information added is not lost even when an image processing is performed with respect to the image data.

10. An image processing method comprising:
extracting, from image data, information related to image processing of the image data according to a first extraction method;
extracting the information from the image data according to a second extraction method different from the first extraction method, when the information cannot be extracted by the first extraction method; and
performing the image processing based on the information extracted.

11. An image processing system comprising an image input apparatus and an image output apparatus, wherein the image input apparatus includes:
a first information addition unit to add to image data information related to image processing of the image data according to a first addition method as first information; and
a second information addition unit to add the information to the image data according to a second addition method different from the first information addition method as second information, wherein at least one of the first and the second information added is not lost even when an image processing is performed with respect to the image data, and the image output apparatus includes:
a first information extractor to extract, from the image data, the information according to a first extraction method;
a second information extractor to extract the information from the image data according to a second extraction method different from the first extraction method, when the information cannot be extracted by the first information extractor; and
an image processing unit to perform the image processing based on the information extracted by one of the first information extractor and the second information extractor.
